(19) United States
(12) Patent Application Publication
(10) Pub. No.: US 2026/0228655 A1
(43) Pub. Date: Aug. 6, 2026

(54) WORK LOCATION MANAGEMENT SYSTEM

(71) Applicant: Automated Cost Tracking Solutions LLC, Oxford, OH (US)

(72) Inventor: Anthony Hicks, Oxford, OH (US)

(21) Appl. No.: 19/150,803

(22) PCT Filed: Dec. 26, 2023
(86) PCT No.: PCT/US2023/085917

§ 371 Date: Jul. 24, 2025

Related U.S. Application Data
(60) Provisional application No. 63/293,253, filed on Dec. 23, 2021.

(51) Int. Cl. G06Q 10/0631; G06Q 10/0633

(52) U.S. Cl. CPC G06Q 10/063114; G06Q 10/0633

(57) ABSTRACT

A work location management server is configured to create and store records for work locations, personnel, and tasks to be performed by personnel at work locations. Each task created for a work location is configured with a work flow that may be executed by the management server to automate assignment of tasks, notifications of assignments, validation and inspection requirements, and other actions. The verifies accuracy of changes in task status by validating those changes based upon information available to the system and based upon information from sensors and devices in the possession of the personnel associated with the task. This may include validating presence at a work location using location information from a mobile device, validating metadata of images or documents submitted from a work location, and machine vision validation of receipts, documents, and other submitted images purporting to show the completion of work at a work location.

### CROSS REFERENCE TO RELATED APPLICATIONS

This application claims priority to U.S. Provisional Patent Application Ser. No. 63/435,004, filed Dec. 23, 2022, the contents of which are incorporated herein in its entirety by reference.

### FIELD

The disclosed technology pertains to a system for managing information, tasks, and personnel related to a work location.

### BACKGROUND

Managing resources such as equipment and personnel at a worksite, whether such personnel are employees or contractors, is a major source of risk, cost, and effort in most fields and industries. This is especially true when work is occurring across a broad variety of locations (e.g., 3-5 personnel at each of a 100 locations) instead of concentrated in an individual location (e.g., 300 or more personnel working in a single building).

While some of these risks can be mitigated through personnel management structures and business processes, such an approach is costly and itself imperfect. For example, personnel who are assigned to verify work being performed by other personnel may fail to thoroughly inspect and verify work for assorted reasons (e.g., workload, simple malfeasance), and so can effectively become a rubber stamp for poor work or practices from others.

Some conventional software platforms provide tools related to workforce management, but such tools are typically general purpose without specialized features, functions, or protections for the employer or employee, such as a general-purpose time clock tool that allows an employee to log time that is claimed to have been worked on a certain task, but that includes no features to verify the likelihood of performance of such work.

What is needed, therefore, is an improved system for managing work and resources across a plurality of work locations.

### BRIEF DESCRIPTION OF THE DRAWINGS

The drawings and detailed description that follow are intended to be merely illustrative and are not intended to limit the scope of the invention as contemplated by the inventors.

FIG. 1 is a schematic diagram of an exemplary system configured to manage work locations.

FIG. 2 is a flowchart of a set of high-level steps that a system could perform to manage work locations.

FIG. 3 is a flowchart of a set of steps that a system could perform to configure work locations and personnel.

FIG. 4 is a flowchart of a set of steps that a system could perform to configure tasks related to a work location.

FIG. 5 is a flowchart of a set of steps that a system could perform to manage workflow related to tasks at a work location.

FIG. 6 is a flowchart of a set of steps that a system could perform to validate portions of a managed workflow.

FIG. 7 is a flowchart of a set of steps that a system could perform to provide geo-fencing related to portions of a managed workflow.

FIGS. 8-16 each show screenshots of exemplary interfaces such as may be presented to users of the system of FIG. 1.

### DETAILED DESCRIPTION

The inventor has conceived novel technology that, for the purpose of illustration, is disclosed herein as applied in the context of work location management. While the disclosed applications of the inventors' technology satisfy a long-felt but unmet need in the art of work location management, it should be understood that the inventors' technology is not limited to being implemented in the precise manners set forth herein but could be implemented in other manners without undue experimentation by those of ordinary skill in the art in light of this disclosure. Accordingly, the examples set forth herein should be understood as being illustrative only and should not be treated as limiting.

Turning now to the figures, FIG. 1 shows a schematic diagram of an exemplary system configured to manage work locations. A management server (100) may include one or more physical, virtual, cloud, or other servers or server environments, which may themselves include processors, memories, communication devices, storage devices, and other components. The management server (100) may be configured to send, receive, store, analyze, manipulate, and create data relating to work location management, and may be configured to communicate with other devices through software interfaces such as APIs, software applications, web browsers, or other communication channels. As an example, the management server (100) may be configured to provide user interfaces to several types of users (e.g., administrative users, personnel users, personnel management users) via a type of specific web browser-based interface that allows that particular type of user to have particular interactions with the system.

Devices or channels in communication with the management server (100) may include mobile devices (102), computers (104), work location-based devices (106), and third-party APIs (108), for example. Mobile devices (102) may include, for example, smartphones, tablets, laptops, vehicle-based infotainment systems, or proprietary mobile computing devices. Computers (104) may include, for example, most computing devices, such as laptops, desktop computers, personal computers, and proprietary computing devices. Location based devices (106) may include devices that are semi-permanently positioned at a work location and configured to interact with devices in the possession of personnel at that work location. Location based devices (106) may include, for example, wireless beacon devices that detect the presence of personnel or other resources at the location and report such information to the management server (100) or may include various other sensors such as motion sensors, object sensors, proximity sensors, or other sensors that may detect the presence of personnel or others at a work location. Third party APIs (108) may include software interfaces that allow the management server (100) to exchange information with other systems or software. As an example, this may include a third-party API (108) for resolving a geo location based on IP address, verifying a license or credential claimed by a personnel, verifying a purchase or transaction displayed on a paper receipt, or other services.

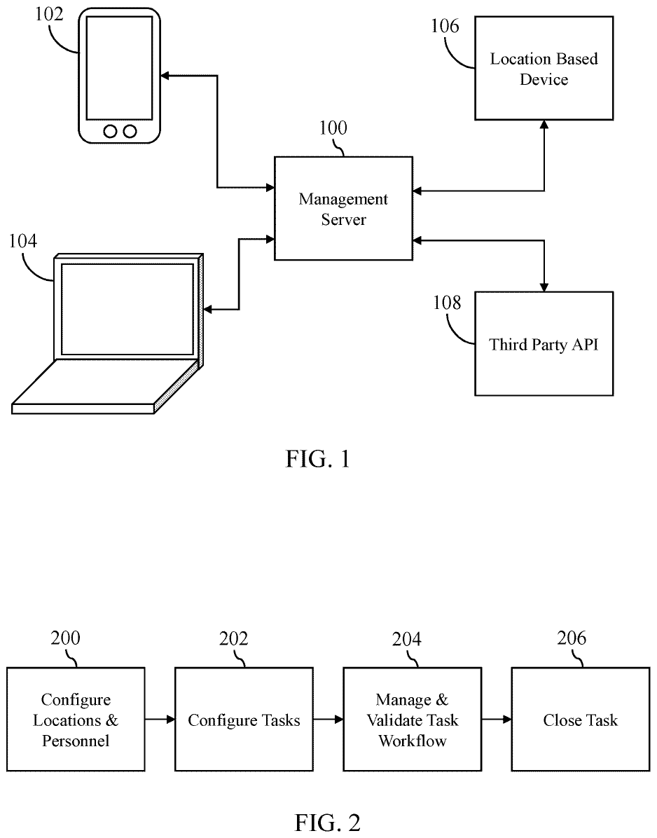

FIG. 2 shows a flowchart of a set of high-level steps that a system could perform to manage work locations, which may include configuring (200) work locations and personnel, configuring (202) tasks for active work locations, managing (204) and validating a workflow for tasks at a work location, and closing (206) tasks once the workflow is completed.

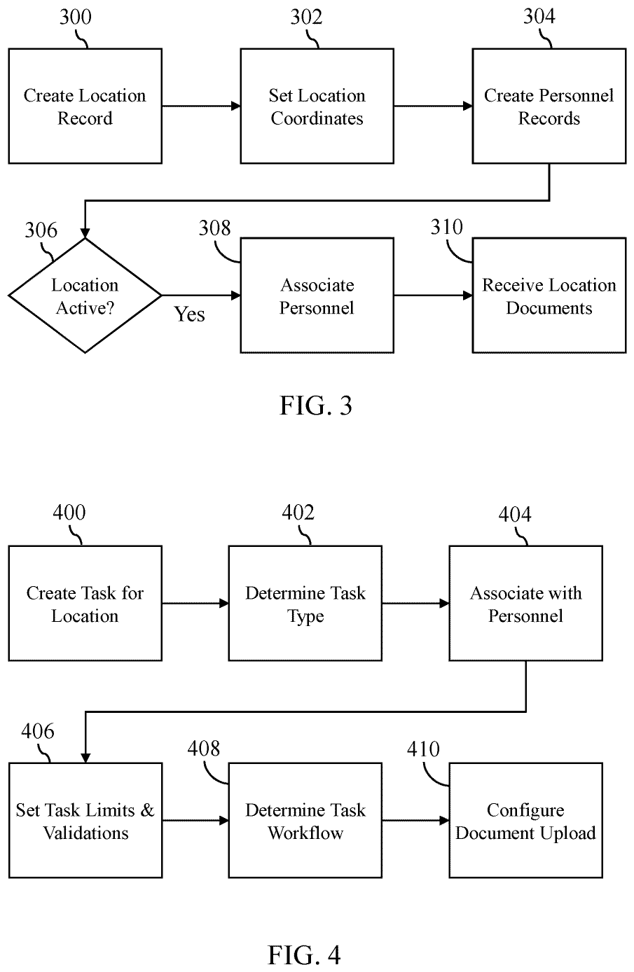

FIG. 3 shows a flowchart of a set of steps that a system could perform to configure work locations and personnel, such as may be performed during the step of configuring (200) as shown in FIG. 2. This may include creating (300) a location record for each work location and setting (302) geographic coordinates for the new work location, which may include providing a description, street address, GPS coordinate location, geo-fenced area or other geographical association, work location type (e.g., construction, renovation, cleanup, installation, etc.), or other characteristics specific to the work location (e.g., licensing requirements, or equipment requirements for personnel at the location). Personnel records may also be created (304) on the system, and may include various personnel information such as name, photo identification, contact information and preferences (e.g., phone number, email address, SMS number, software application notification), work location capabilities such as the type of work capabilities, certifications to perform certain types of work, or equipment or other resources to perform certain types of work that the personnel provide. Creating (304) personnel records may also include creating a personnel specific account for each personnel that allows them to interact with the management server (100) via a website, software application, or other communication channel (e.g., SMS, phone call).

As locations are configured (300) they may be classified as active or inactive in the system, depending upon the status of work at the location. For example, a work location that is still a potential work location, or a work location that is confirmed but is awaiting details or other requirements before it begins may be inactive, while a work location that is confirmed and ready for work to begin may be active. Where a particular work location is active (306), the management server (100) may associate (308) personnel from the created (304) personnel with the work location and may begin to receive (310) and store uploaded documents and other data related to the work location. Association (308) of personnel may be performed manually or automatically, such as by the management server (100) automatically selecting personnel from created (304) records based upon those personnel's listed capabilities, and the characteristics of the created (300) location record or work tasks, as will be described in more detail below. As an example, personnel may be automatically selected and associated (308) based upon their geographic location in relation to the work location, or their possession of a particular training, equipment, or other qualification required by the work location.

Received (310) location documents may be uploaded by administrators or other users of the system, and may include such details as high-level plans, diagrams, designs, descriptions, or project details related to the worksite, such as a blueprint of new construction building, or may include documents related to confirming the work location as active, such as a signed document or project plan. Received (310) location documents may be viewable by some but not all users of the management server (100), such that administrators, managers, or other positions may view them, while individual personnel (e.g., contractors or consultants) may not.

FIG. 4 shows a flowchart of a set of steps that a system could perform to configure tasks related to a work location. When a work location is active, the management server (100) may create (400) tasks for the location, either based upon manual inputs or automatically. Created (400) tasks may include descriptions of tasks, designs, diagrams, images, or other visual descriptions of tasks, parts, materials, or equipment lists related to performing tasks, date ranges in which tasks must be performed, estimated time or costs of tasks, and other characteristics or requirements of tasks. A task type may also be determined (402) upon creation, such as by selection from a drop-down box or other menu, with each task type having certain characteristics. Automatic task creation may be performed by the server (100) based upon the created (300) work location, for example, where a work location has been broadly categorized as “renovation” for its task type (402), the server (100) may automatically create work tasks for each room or each floor of a building located at the work location based upon configured tasks related to each renovation (e.g., old carpet removal, installation of new carpet, clean and prep, painting). Manual creation (400) of tasks may include an administrator or manager providing details related to unique tasks based upon their own experience and interpretation of blueprints, project details, or other project documents.

As tasks are created (400), they may be manually or automatically associated (404) with personnel to perform them. These personnel may have been previously created (304) in the system, associated (308) with the particular work location for which the task is being created, or may be selected from unassociated personnel based upon an unforeseen need. As with prior examples, automatic associated (404) of personnel may be based upon comparisons of the personnel's characteristics and capabilities to the configured and predetermined requirements of a particular work location as may be determined by its type (404), the newly created task (400), or both. As an example, where a created (400) task is for painting a room with a high ceiling, personnel (404) that have configured painting with scaffolding or other equipment as a capability may be automatically associated (404) with the task. This association (404) may also be manually performed based upon experience or other factors, as with prior examples. With all potentially automated decisions made by the management server (100), such decisions may be fully automated (e.g., they are performed invisibly) or may be made by way of an automated suggestion (e.g., appropriate personnel are automatically identified and offered as options to be manually confirmed).

When creating (400) tasks, task limitations and validation requirements may also be set (406) automatically, based upon such factors as task type and associated personnel, or manually. As an example, any task that is related in the system to a geo-fenced area of a work location may be configured to require geo-fencing validation to be performed by a personnel, which may require that a user device of the personnel report a valid GPS location or other indication of presence within the geo-fenced area in order to receive effort or cost from that personnel in the form of billed work hours or used materials. In addition to validations, task limitations (406) may include cost limits, material limits, hour limits, date, and time range limitations (e.g., work may only be performed on weekdays, between 6 PM and 10 PM). Other examples of limitations and validations that may be automatically enforced by the management server (100) exist, such as those described in more detail below. As with prior examples, automatic setting (406) of task limits and validations may be based on previously provided information related to the work location (e.g., a limitation requiring work to be performed only on weekends for a work location that is configured with weekday business hours), certain personnel (e.g., excluding some personnel from a project based on other personnel already assigned to the project), or certain tasks (e.g., limiting cost billed to a certain task based upon a firm cost estimate associated with the task).

With a plurality of tasks created (400) for a work location, the management server (100) may then determine (408) a workflow for each task and may begin to automatically execute that workflow. Several types of tasks may have different workflows depending upon their type, characteristics, limitation and validation requirements, and other characteristics. For example, a task type related to cleaning up a work location may have a simple workflow such as (a) notify personnel to start, (b) receive confirmation of personnel start, (c) receive confirmation of task complete, (d) finalize task and notify manager, while a task type related to new construction or more complex work may be more complex, with multiple points that require on-site inspection of in process work, or multiple milestones that must be reported and confirmed in order to receive partial payments. The system may also prepare (410) a repository for file uploads related to tasks, in order to receive documents, images, or other files related to progress of the task through its associated workflow. Such file repositories may be tracked and version controlled and configured to enforce de-duplication of data in order to minimize impact on storage and network capabilities, and may be further configured to provide variable read/write capabilities based upon particular user types of the management server (100) (e.g., personnel may be able to upload and view their own documents, but unable to modify any documents, or view documents of other personnel).

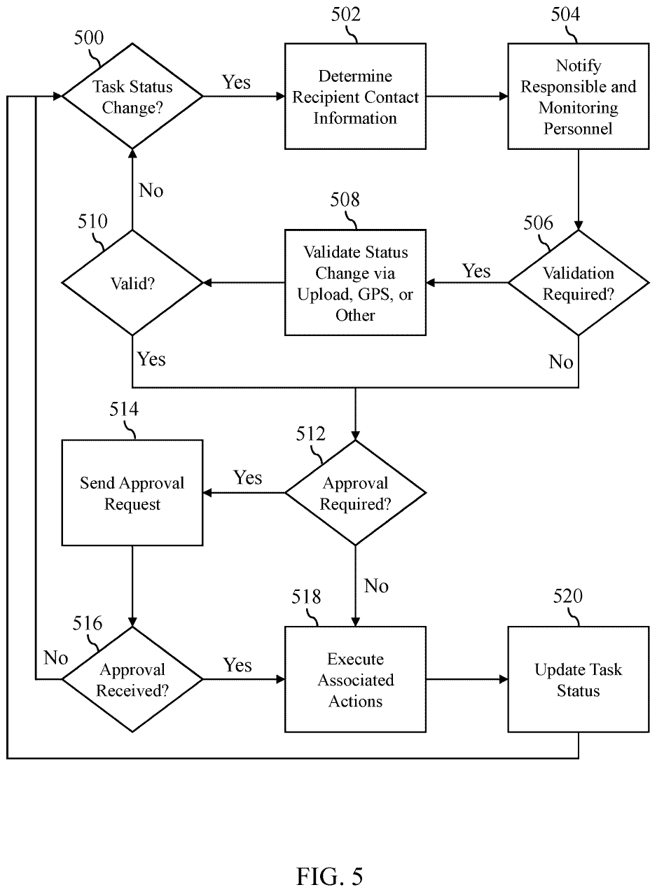

FIG. 5 shows a flowchart of a set of steps that a system could perform to manage workflow related to tasks at a work location. While managing workflow, the management server (100) may trigger a change (500) in status for any task, which may include creation of the task, modification of the task, or any received action or other activity related to the task. As an example, this may include time, effort, cost, materials, or progress reported on the task, modification of the task's requirements or characteristics, failure of a validation or enforcement of a limitation on the task, or other changes in status. When a change (500) is detected, the system may identify recipients of updates related to that task, which may include personnel associated with performance, monitoring, or inspection of the task and determine (502) their contact information and preferences, and then notify (504) them of the change (500) in status, which may include providing notifications to one or personnel performing the work, other personnel monitoring performance of the work, or others. Such communication may be provided across multiple channels, such as by a website notification, software application notification, email, electronic text message, or telephone voice call, and may be provided in a format where a response may be provided via the same channel and logged to the workflow for the task. As an example, a notification may be provided by electronic text message with instructions for responding to confirm that the task has been started or completed, with such response being received by the management server (100) and logged as a further change (500) in status.

Certain types of task status changes (500) may trigger validation (506) requirements of the workflow, as previously discussed. This might include validating that equipment or materials have been delivered to a work location before allowing time to be logged to the work location, validating that a personnel clocking in at a location is actually present at the location, validating that a completed task has been inspected before confirming payment for the task, and other examples. Where validation is required (506) the system may validate (508) the status change based upon the particular status change and configured validations, which may include receiving and validating location information associated with the status change, receiving, and validating documents (e.g., text documents, photographic images of receipts, purchased materials, or completed tasks), or other validations, as will be described in more detail below. Where the status change is determined to be invalid (510), the system may update the task status to indicate failure of the validation, which may trigger subsequent notifications to the associated personnel so that the task may be re-performed or modified and re-validated.

Validations performed by the system will vary by implementation but will often include utilizing the sensors and capabilities of a mobile device (102) or other device in the possession of personnel to inform the credibility of veracity of the status change. As an example, where a first personnel reports that a task is complete, the system may require an image of the completed work be uploaded, and may validate the photograph based on factors such as metadata (e.g., GPS location at which the photo captured matches work location, device creating the photo matches personnel device), based upon manual inspection (e.g., display the photo to an administrator via a web interface for confirmation), or based upon machine vision analysis of the image (e.g., a machine vision algorithm determines that the image is of a worksite with newly installed carpet or fixtures).

Where validation is not required (506), or where validation passes (510), the system may determine whether the workflow requires approval (512) from any other user of the system, such as a manager, administrator, work location inspector, etc. Approvals may be required for certain stages of a task workflow, or all stages of a workflow, and may be variably configured depending upon a particular implementation. In some implementations, requirements may be tied to certain types of task changes, such as those that will trigger major task milestones, payments, reimbursements, or other similar changes. Where approval is required (512), the system may send an approval request (514) to the personnel associated with the task in an approving role (e.g., a manager, site inspector, project coordinator, etc.). As with prior examples, this may be in the form of a website notification, software notification, electronic text message, telephone call, or other communication channel, and provide pre-formatted options for responding via the same channel, such as where an email may be sent to a site inspector with an image of a work location where a task was recently completed, and the site inspector may respond with a preformatted message to verify completion of the work and initiate payment or reimbursement for the task. Where approval is not received (516) in response, the system may update the task (500) to trigger a status change and recirculate the task through the workflow in order to resolve any issues that prevented approval.

Where approval is received (516), or not required (512), the system may execute (518) any actions associated with completing that stage of workflow for the task and may update (520) the task so that it proceeds to a next step or stage of its workflow. Actions executed (518) by the system may include, for example, creation or assignment of additional tasks, assignment of additional personnel, changing the status of that work location or a different work location between active and inactive, request or purchase of materials or equipment related to the task, or payments related to the task workflow.

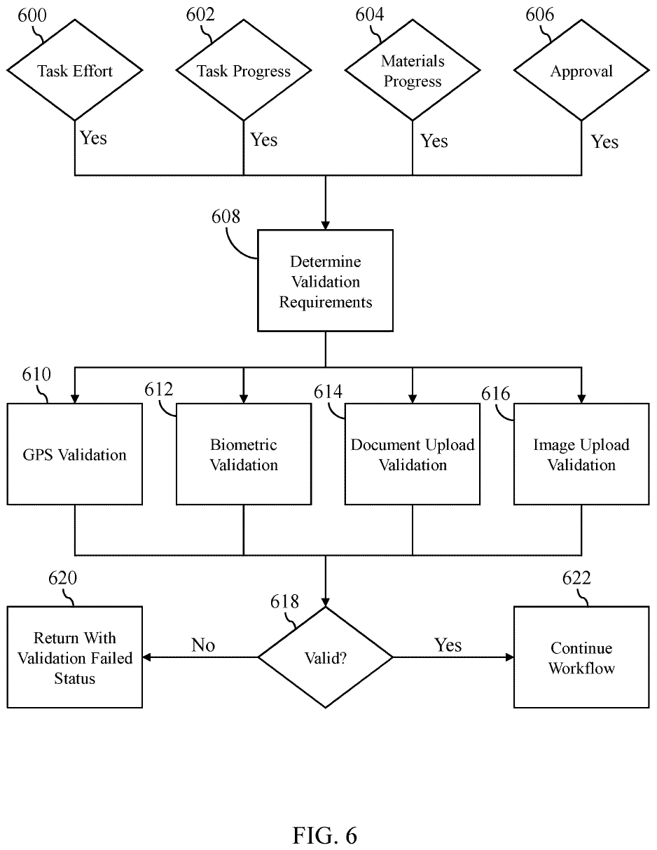

FIG. 6 shows a flowchart of a set of steps that a system could perform to validate portions of a managed workflow. As has been described above, the management server (100) may provide additional validation of task changes throughout a workflow, in addition to automating communication and progress of the task through its workflow. Examples of this may include changes to the task status that indicate effort being logged to the task (600) (e.g., hours logged by personnel working on the task), progress of the task (602) (e.g., milestone or percentage based completion of the task, as reported by personnel or inspectors), progress related to materials associated with the task (604) (e.g., installation of equipment or fixtures, use of materials), or approvals (606) received from parties during various portions of the workflow (e.g., approval from a work location inspector that a task has been completed).

As the workflow management server (100) receives indications of these types of changes, it may determine (608) whether any validation requirements have been configured to apply to that portion of the workflow. Such validations may include, for example, a GPS based validation (610), biometric validation (612), document upload validation (614), image upload validation (616), or other types of validation. As an example, a contractor may access the management server (100) via their mobile device (102) using a website interface or software application interface and indicate that effort is being logged to the task by that contractor. The system may perform GPS validation (610) of this effort based upon location information provided by the mobile device (102) to verify that the contractor is at the work location of the task they are logging effort to, or may perform biometric validation of a fingerprint, voice capture, facial image capture, or other biometric information captured by the user device (102) when effort is logged (600), which may prevent fraudulent logging of effort to the task in various scenarios.

Continuing the example, the contractor may have purchased supplies relating to the task that may be reimbursed during execution of the task workflow. The workflow may require an image of the receipt for the supplies to be captured and uploaded and may perform optical character recognition or another process to capture and confirm the types, amounts, and costs of supplies as reflected on the receipt, and separately submitted by the contractor. When the contractor updates the workflow to indicate that the task is complete, the workflow may require an inspector to travel to and inspect the work location to confirm completion of the task and may perform GPS validation (610) through the inspector's mobile device (102) to confirm travel to the work location, and require one or more images to be captured and uploaded (616) of the completed work to confirm completion of the inspection. Uploaded images (616) may be validated based upon metadata (e.g., confirm GPS location of capture matches work location, confirm capture device matches inspector's registered device, etc.), manual inspection, or machine vision analysis, as has been previously described. The above are merely examples, and other examples, personnel roles, and workflows related to validation are possible with the disclosed system and will be apparent to those skilled in the art in light of the disclosure herein.

Where validation is completed (618) without error, the management server (100) may continue to execute (622) the workflow for the task, as has been described. Where validation fails (618), the system may update and return (620) that portion of the workflow to reflect the failed validation and prompt the associated personnel to re-perform that step of the workflow or provide additional information to pass validation. This may include, for example, attempting to complete that stage of the workflow from a proper location (e.g., at the work location, from within a geo-fenced region associated with the work location), providing additional document uploads (614), providing additional image uploads (616), or other steps.

One advantage of the disclosed system is the use of the capabilities of user devices associated with the management server (100) as an extended network of devices, allowing for an extremely scalable and flexible system. As one example of this, the system may utilize location information (e.g., GPS data, Wi-Fi triangulation, or other location information sources) to provide various geographic data about personnel that may be used to verify, validate, and automate various aspects of the workflow.

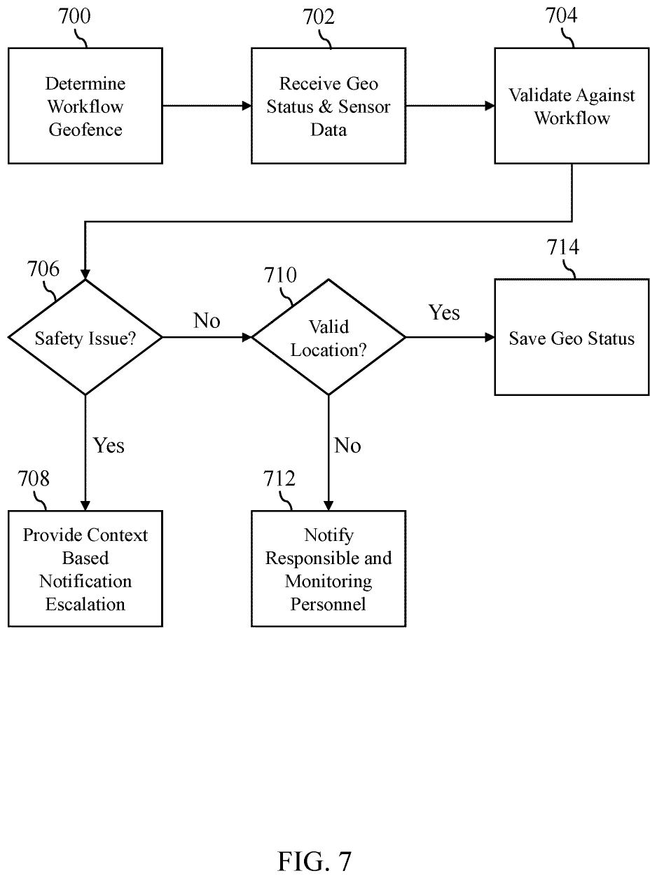

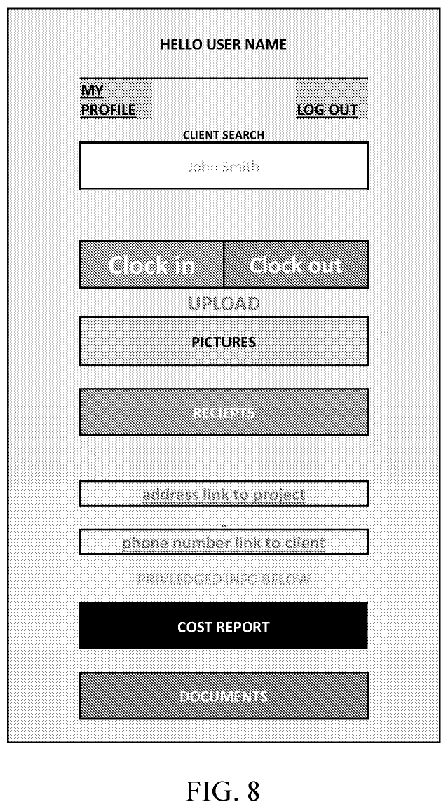

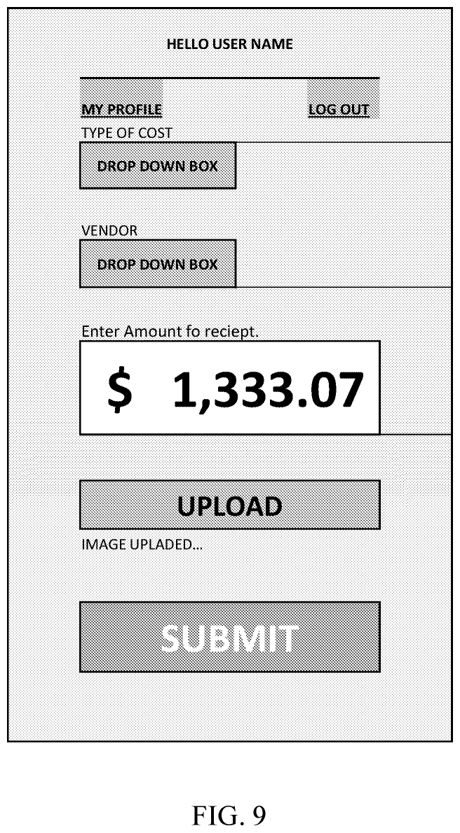

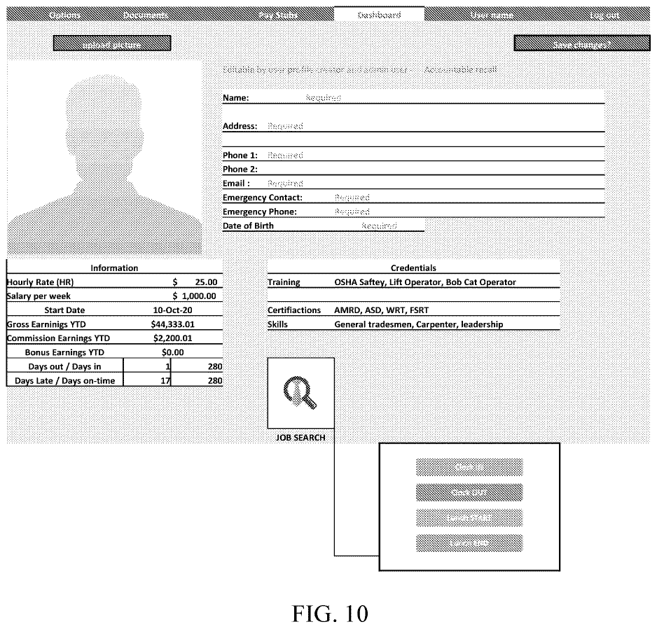

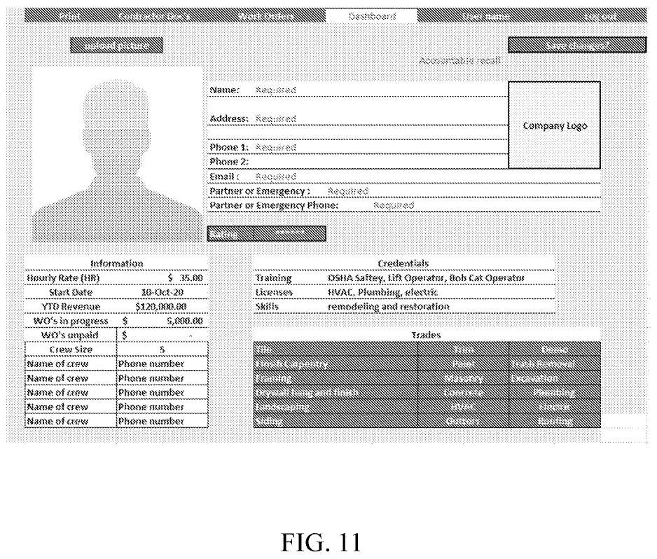

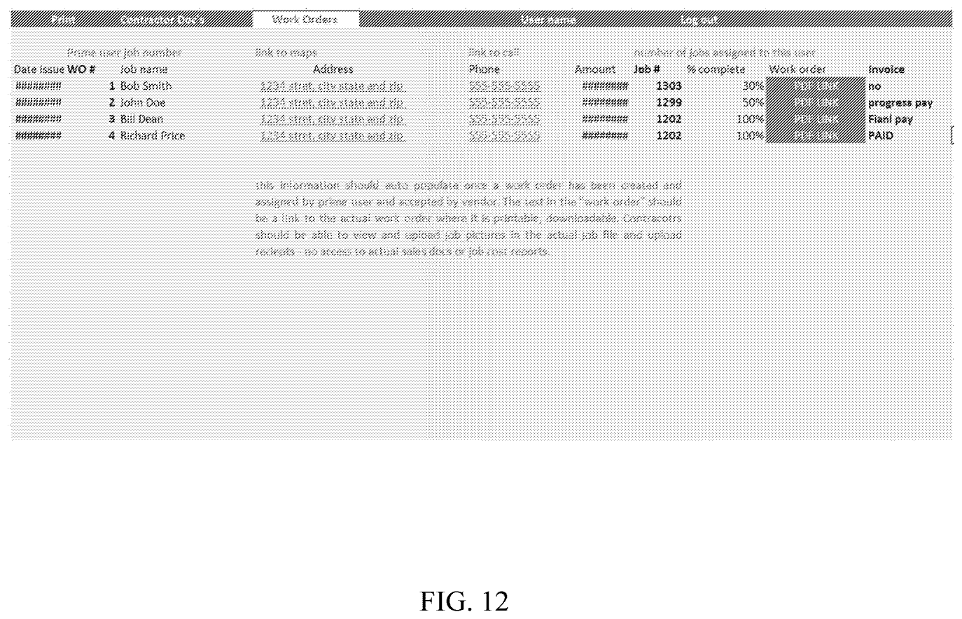

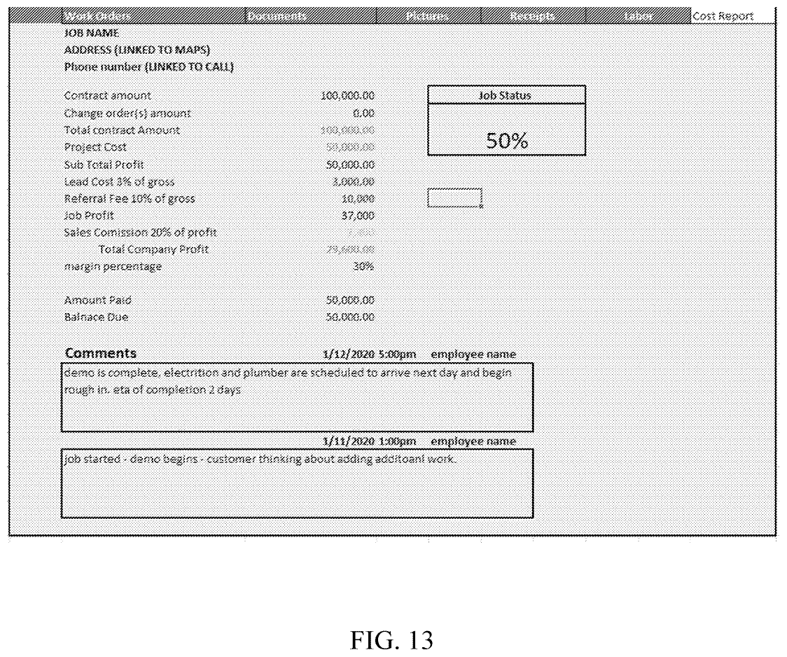

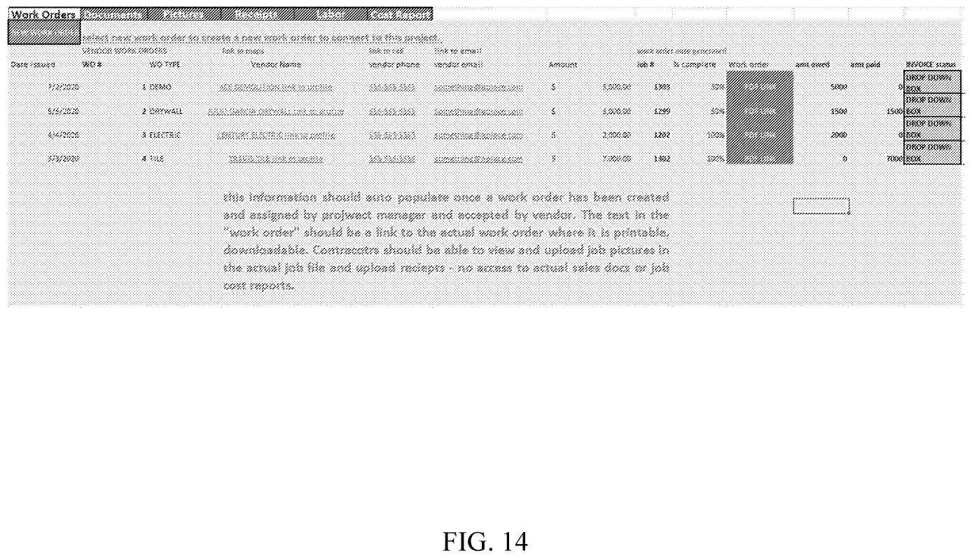

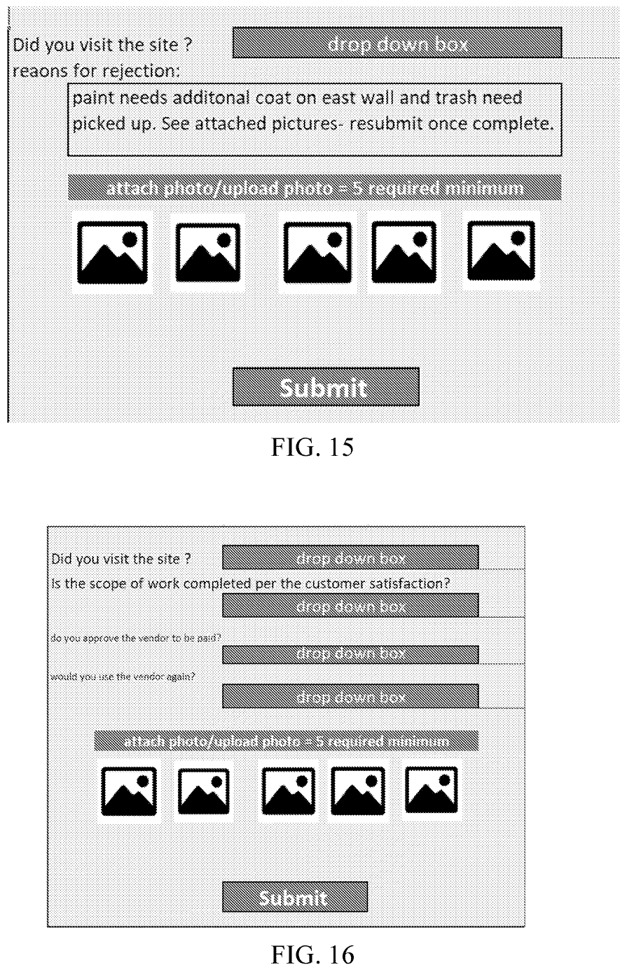

As a further example, FIG. 7 shows a flowchart of a set of steps that a system could perform to provide geo-fencing related to portions of a managed workflow. In addition to associating geo-fencing with a work location, individual portions of the workflow may also be associated with their own geo-fencing characteristics (e.g., either small areas within a larger geo-fenced region of the work location, or separate areas that personnel might travel to from the work location in order to obtain equipment or supplies). As a result, the system may, any time location information or other sensor information is received (702) from a personnel's mobile device (102), determine (700) the ideal or acceptable geo-fenced area for that location information (702) to fall within and validate (704) that location information against the workflow. In addition to identifying and preventing fraudulent activity by personnel, this may utilize the capabilities of the user devices (102) of personnel to provide safety features.

For example, information derived from the mobile device (102) may indicate unsafe driving (e.g., time and distance between GPS locations indicates unsafe speed, erratic GPS locations relative to road maps indicates lack of control) or the occurrence of a traffic accident (e.g., mobile device (102) accelerometer reports acceleration consistent with driving a vehicle, and a sudden deceleration consistent with an automobile accident). This information may also be used to detect the occurrence of accidents or safety issues at a work location, such as accidental falls (e.g., based upon mobile device (102) accelerometer data), hazardous conditions (e.g., extreme temperatures), or localized emergencies (e.g., based upon mobile device (102) audio capture of sirens, alarms, or other emergency activity). Generally, any information that may be captured by the mobile device (102) or other user device during participation of that device in the workflow may be analyzed to identify whether a safety issue exists (706), and the management server (100) may automatically provide corresponding context-based notifications and escalation (708). As an example, data from a mobile device indicating slightly excessive speeds while driving to or between work locations may result in a reminder to that personnel's mobile device to be cautious, while data indicating a traffic accident or a fall from a ladder may result in a prompt to that personnel to confirm whether they are okay, and if no response is received, an escalation to other nearby personnel and/or emergency responders.

Information from personnel devices may also be used to validate their location during various portions of the workflow, as has been described. This may include verifying presence at a work location when effort is being logged, presence at a business or retail location when reimbursable supplies or equipment have been reported, presence at a work location when an inspection of completed work has been reported, and other examples. Where the location is valid (710), the workflow may continue as normal and the personnel's geo status may be logged (714) over time. Where the location is invalid (710), the system may take varying actions depending upon the particular stage of the workflow. This may include notifying (712) responsible and monitoring personnel of the invalid geolocation, which may include notifying the personnel that they are not at the correct work location for their logged effort, notifying a supervisor of the unexpected location, or both.

In some implementations, geolocation may also be used automatically as it is received for purposes beyond validations, such as automatic effort logging (e.g., a virtual “clock in” upon arrival to a geo-fenced area of particular work location, and a virtual “clock out” upon existing the geo-fenced areas of the work location), or automatic management and display of work location maps showing personnel currently at various work locations across a geographic area. In addition to automatic notifications as have been described herein, the management server (100) may also allow for manual communication, via the software platform itself, between personnel. This may allow each personnel to be configured with permissions allowing them to communicate with others via the management server, such as a messaging platform allowing contractors and general contractors to exchange communications via the system that are not an automated portion of the workflow. As with prior examples, such communication may be performed across multiple channels depending upon personnel preferences, such that a message sent by a manager via a website might be received as an electronic text message, as an email, and as an automated voice call by the intended personnel.

The management server (100) may also utilize information about personnel, work locations, tasks, and registered mobile devices (102) to provide access control functions for supplies, equipment, work locations, and other areas. As an example, where a particular work location is secured by an automated locking mechanism, the management server (100) may configure the personnel's mobile device (102) to store an electronic certificate that allows the automated locking mechanism to be unlocked and provide access to the work location (e.g., or storage container, tool storage, etc.), or may configure the automated locking mechanism to recognize the mobile device (102) and unlock while it is within a certain proximity.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A method for managing work locations, comprising:
a. configuring work locations and associated personnel within a computer-based system, wherein said configuring comprises defining spatial parameters and assigning personnel to respective work locations;
b. configuring tasks specific to active work locations within the computer-based system, wherein said configuring comprises creating, categorizing, and assigning tasks to the defined work locations;
c. managing and validating workflows for tasks associated with a work location within the computer-based system, wherein said managing comprises tracking task progress, verifying task completion according to predefined criteria, and ensuring adherence to established workflows; and
d. closing tasks upon completion of their respective workflows within the computer-based system, wherein said closing comprises updating task status, archiving task-related data, and releasing associated resources.
